(19) United States
(12) Patent Application Publication
(10) Pub. No.: US 2025/0326044 A1
(43) Pub. Date: Oct. 23, 2025

(54) JOINT AND METHOD OF JOINING

(71) Applicant: Tokamak Energy Ltd, Oxfordshire (GB)

(72) Inventors: Greg Brittles, Oxfordshire (GB); Sergey Belyakov, Oxfordshire (GB)

(21) Appl. No.: 18/870,155

(22) PCT Filed: May 30, 2023
(86) PCT No.: PCT/EP2023/064450

§ 371 Date: Nov. 27, 2024

(30) Foreign Application Priority Data
May 30, 2022 (GB) 2207984.2

(51) Int. Cl. B23K 1/00; G21B 1/05; H01F 6/06

(52) U.S. Cl. CPC B23K 1/0008; H01F 6/06; G21B 1/055; G21B 1/057

(57) ABSTRACT

A method of joining a first substrate and a second substrate to thereby form a joint. A stack is provided, including filler material and a plurality of retention mediums, between the first and second substrate. The stack is heated to melt the filler material and to wet the first and second substrate with melted filler material. Said melted filler material is allowed to solidify to form the joint.

### FIELD OF THE INVENTION

The present invention relates to a joint, in particular to a soldered or brazed joint and a method of joining.

### BACKGROUND

Soldering and brazing are methods of joining metallic components (called “substrates”) together using a lower melting point filler material (e.g., a solder or braze).

In both soldering and brazing, the filler is melted, such that: i) it flows and fills the space between the solid substrates; and ii) it wets the opposing surfaces of the solid substrate to be joined. Depending on the materials chemistry, the solid substrate dissolve in the liquid filler to form an intermetallic layer. Typically, this intermetallic layer is brittle but it anchors the filler to the substrates. After any remaining liquid filler has solidified, a thermal, electrical and/or mechanical connection is established between the substrates.

The main difference between soldering and brazing is in the melting point of the filler material. In soldering, the filler has a melting point less than 450° C., whereas, in brazing the melting point of the filler is greater than 450° C. But for this difference, soldering and brazing are largely the same. In both soldering and brazing, the substrates remain below their melting points.

### SUMMARY

It is an object of the present invention to provide a new and useful joint and method of manufacture thereof.

According to a first aspect of the invention, there is provided a method of joining a first substrate and a second substrate to thereby form a joint. A stack is provided, comprising filler material and a plurality of retention mediums, between the first and second substrate. The stack is heated to melt the filler material and to wet the first and second substrate with melted filler material. Said melted filler material is allowed to solidify to form the joint.

According to a second aspect, there is provided an apparatus comprising a first substrate, a second substrate and a joint between the first substrate and the second substrate. The joint comprises a plurality of retention mediums arranged to form a stack between the first and second substrate; and filler material extending between the first and second substrate and through the stack.

According to a third aspect, there is provided a plasma confinement vessel, comprising the apparatus according to the second aspect, wherein each of the first and second substrates are a coil of a superconducting magnet.

Further embodiments are provided in claim 2 et seq.

### BRIEF DESCRIPTION OF THE DRAWINGS

Some embodiments of the invention will now be described by way of example only and with reference to the accompanying drawings, in which:

FIG. 1A and FIG. 1B is a schematic illustration of liquid held between parallel plates;

FIG. 2A shows a joint;

FIG. 2B shows an exemplary retention medium structure;

FIG. 3 shows a first exemplary joint to-be-made having variable-thickness;

FIG. 4 shows a second exemplary joint to be-made;

FIG. 5 shows a third exemplary joint to-be made; and

FIG. 6 shows a fourth exemplary joint to-be-made.

### DETAILED DESCRIPTION

In practice, there is a lower and upper limit for the thickness of soldered or brazed joints, because:
In low-thickness joints (<5 μm), the brittle, intermetallic layer makes up a significant fraction of the joint. Low-thickness (<5 μm) joints are therefore too brittle for use in a load bearing component.
In high-thickness joints (>250 μm), the melted filler has a tendency to flow, under the effect of gravity or otherwise, away from the space between the substrates to be joined. This leads to incomplete filling and void formation in the joint. Correspondingly, high-thickness joints are also mechanically weak.

Further thickness restrictions may be imposed if the joint needs to be manufactured to a prescribed tolerance in strength, electrical and/or thermal conductivity.

For large (e.g., >30 cm in their largest dimension), heavy substrates, and/or those of complex shape, it is difficult to establish a joint having a maximum thickness less than 250 μm and a minimum thickness greater than 5 μm across the entire joint area. Tighter tolerances are even more difficult to achieve. There is therefore a need in industry for an improved joint, which can be more easily made to a prescribed thickness tolerance and/or a method of retaining solder within a proposed joint of a non-conventional dimensions (e.g., variable thickness, thickness greater than 250 μm).

It is proposed, therefore, to place a (filler) retention medium, having a thickness greater than 5 μm, between the substrates to be joined, which is configured to hold a predetermined volume of filler. The retention medium is configured such that flow of the liquid filler away from the space to be jointed is restricted. Advantageously, the thickness of the joint is not limited to the upper bound referred to above (e.g., incomplete filling due to loss of filler is avoided) and joints with thicknesses greater than 250 μm are achievable. For example, joints having a thickness greater than 1 mm are possible using a single retention medium. Even thicker joints are possible using more than one retention medium. Thicker joints generally have improved strength over thinner joints.

The joint described herein may either be formed through soldering or brazing. As has already been mentioned, the primary difference between soldering and brazing is the melting point of the filler. Soldering and brazing should therefore, unless expressly stated otherwise, be treated as interchangeable methods.

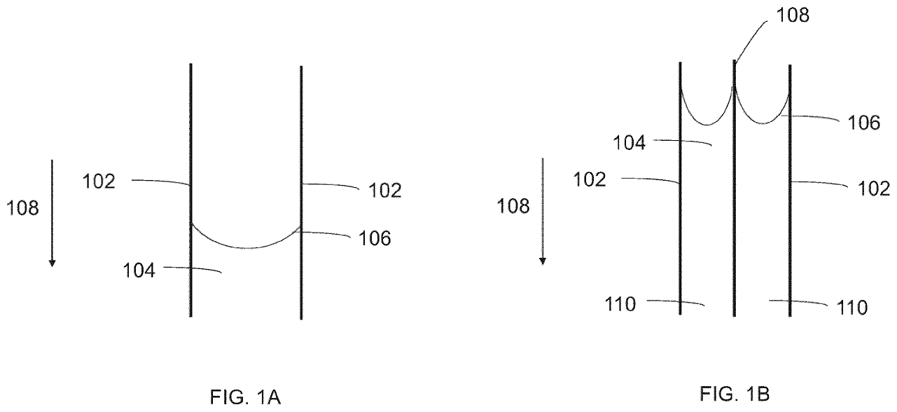

FIG. 1A shows a column of liquid 104 held between two parallel plates 102 through capillary action. The weight of the column of liquid 104 acts downwardly, whereas the surface tension of the liquid acts upwardly since a meniscus 106 develops. The total height of the column of liquid 104 which can be held between the parallel plates is inversely proportional to: i) the separation of the plates 102; and ii) the density of the liquid; and proportional to the surface tension of the liquid. This principle similarly applies to other geometries, for example, if the parallel plates 102 are substituted with a cylindrical tube, or mesh. If the weight of the liquid 104 is too large compared to the capillary forces, the volume of liquid 104 held between the plates 102 decreases to match until equilibrium is reached with the capillary forces. This leads to flow of liquid 104 from the space between the plates 102 and to a decrease in the liquid level in FIG. 1A.

Referring now to FIG. 1B, a further parallel plate 108 is arranged between the two parallel plates 102 shown in FIG. 1A. The level of the liquid 104 held between the plates 102, 108 can then increase because the minimum separation between plates 102, 108 decreases. The further parallel plate 108 increases the capillary force that holds the liquid 104 between the plates 102, such that, compared to the arrangement in FIG. 1A, a larger separation between plates 102 can be tolerated before loss of liquid due to gravity.

More generally, a retention medium is able to hold liquid filler through capillary action, provided that: it is structured to define a plurality of interstices within itself and/or with the substrates, having a minimum dimension no greater than a threshold. Referring to FIG. 1A, the further parallel plate 108 defines an interstice 110 between each parallel plate 102 and the plate 108.

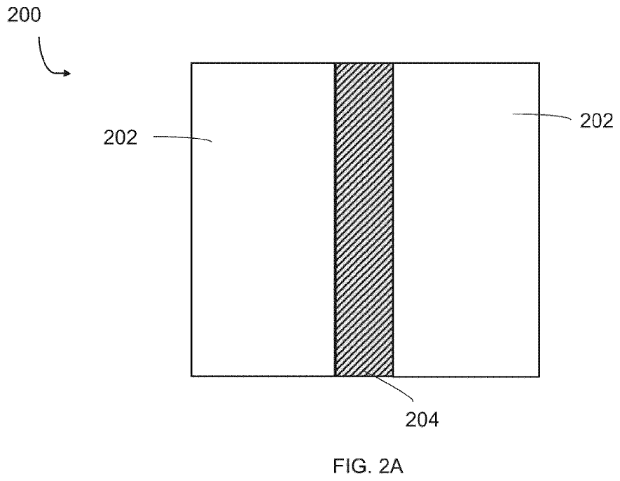

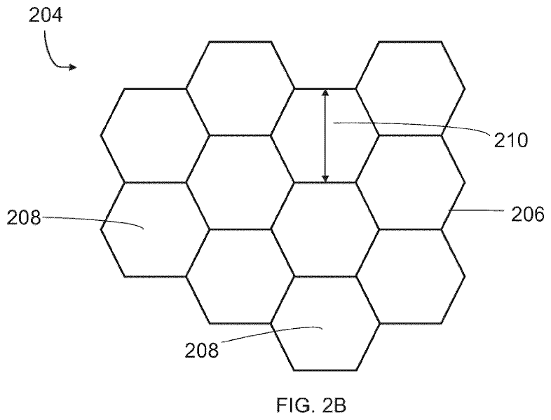

FIG. 2A shows a joint 200 between two substrates 202, comprising a retention medium 204 arranged between the substrates, and a filler material (e.g., a solder or braze and referred to herein as “filler”) arranged between the substrates and within the interstices of the retention medium.

Referring now to FIG. 2B, the retention medium 204 may comprise a plurality of interconnected or interlaced elements 206 (e.g., wires), which form an open network, such as a mesh or gauze. The network defines a plurality of interstices 208, in which liquid filler may be held through capillary action. The minimum dimension 210 of the interstices is no greater than a threshold, such that the liquid filler can be held, through capillary action, within the interstices 208 without loss of liquid due to gravity. In the specific example illustrated, the network forms a honeycomb structure. Other network structure are possible: for example, cubic, rectangular, triangular, as the skilled reader appreciates.

For regularly shaped interstices (e.g., square, hexagon, rectangle), the minimum dimension 210 is defined as the shortest straight line distance between any point on one element 206 and any point on another element 206, which passes through the centre point (i.e., the centre of symmetry) of the interstice. For example, the minimum dimension of an equilateral triangle is the distance between the midpoint of one side and the opposing corner. The minimum dimension of a square is the distance between the midpoints of opposing sides. For irregularly shaped interstices, the minimum dimension is the shortest straight line distance between any point on one element 206 and any point on another element 206, which passes through the centre of mass of the interstice. Phrased differently, for either regular or irregularly shaped interstices, the minimum dimension of the interstice is such that, the shortest distance between any point within the interstice 208 and the retention medium (e.g., a point on one of the elements 206) is no higher than half the above threshold.

The network of the retention medium 204 shown in FIG. 2B is two-dimensional. That is, the honeycomb structure extends in one plane only. In such an example, the interconnected elements 206 have a thickness sufficient to extend across the gap between the substrates 202. The skilled reader would appreciate that, in practice, the thickness of the joint to be made is predefined. The skilled reader could, for example, adapt the thickness of elements 206 to match that thickness.

In another example, the network (e.g., the honeycomb structure) of the retention medium 204 may extend in three dimensions (e.g., thereby forming a (hexagonal) prismatic structure), for example, such that it has sufficient thickness to extend across the gap between the substrates 202. The interstices 208 are therefore also three dimensional.

In another example, the retention medium 204 may comprise a plurality of “two-dimensional” network layers (e.g., the honeycomb structure shown in FIG. 2B) stacked upon one another. The layers, when stacked together, have a thickness sufficient to extend across the gap between the substrates 202. The skilled reader would appreciate how to vary the thickness of these layers and the number of the layers to fill the gap between the substrates 202. As one example, each layer may comprise a mesh formed from interconnected or interlaced wires, with the thickness of the layer depending on the thickness of the wires. Where the wires are interlaced (e.g., in a woven mesh), the thickness of the layer may be approximately double the thickness of the wires. A thickness of each retention medium may be in a range of 25 μm to 200 μm, or more preferably in a range of 50 μm to 150 μm.

The interstices 208 of each immediately adjacent layer may either be aligned (“AA” stacking) or offset (“AB” or “ABC” stacking) with one another. In AB stacking, the interstices 208 of each alternate layer are aligned with one another. In ABC stacking, the interstices 208 of layers (e.g., layer “A”) in the retention medium 204, which are immediately separated by two layers (e.g., layers “BC”) are aligned with one another. For example, interstices of a first layer in the retention medium 204 are aligned with the fourth layer; interstices of the second layer are aligned with the fifth layer; and interstices of the third layer are aligned with the sixth layer. In both AB and ABC stacking, the interstices 208 of each immediately adjacent layer are offset.

The numerical value of the threshold depends on a number of parameters and their interplay, including:
the density of the liquid filler (the larger the density of the filler, the smaller the threshold because the magnitude of weight increases, whereas the magnitude of capillary forces is unchanged); and
the difference between the surface energy of the liquid filler—retention medium interface and the surface energy between of the liquid filler—atmosphere (or vacuum) interface (the larger the difference, the larger the threshold can be because this results in a greater capillary force). The interfacial surface energies controllably depend on:
   the degree of impurities/contaminants (e.g., oxides, or Ar/N adsorbed layers) on the liquid filler and/or substrate, which form through chemisorption or adsorption of gases present in the surroundings. To an extent, the degree of impurities/contaminants can be controlled using a controlled atmosphere (e.g., Ar, N, air atmospheres) or using treating the substrates to be joined with a flux to remove surface oxides or other contaminants;
   temperature; and
   pressure.

In specific examples, the threshold is less than or equal to 225 μm, more preferably less than or equal to 200 μm, even more preferably less than or equal to 150 μm, 125 μm or 100 μm, such that the minimum dimension of one or any one of the interstices 210 in the network is less than 225 μm, more preferably less than 200 μm, even more preferably less than 150 μm, 125 μm or 100 μm. This ensures capillary action is sufficiently large to hold the filler in the retention medium 204, or, at least partially, restrict flow of filler from the retention medium 204. A minimum size of the interstices in the retention medium 204 may depend on the ability of liquid filler to infiltrate or permeate the retention medium, reducing voids of trapped gas/vacuum. Thus, the size of the interstices may be in the range 10 μm to 200 μm, or more preferably 50 μm to 150 μm.

It is noted that, a joint 200 comprising a retention medium 204 may have lower electrical/thermal conductivity compared with an equivalent joint without the retention medium 204 as the retention medium 204 may represent a barrier to thermal or electrical conduction. In this regard, where such properties of the joint are important, the minimum dimension of the interstices 208 is preferably close in value to the threshold to avoid excessive barriers in the joint and to increase the proportion of filler and the number of retention medium layers minimised.

Referring back to FIG. 2A, the joint 200 may be generated by: inserting a retention medium 204 pre-impregnated with (solid) filler between two substrates 202, wherein the retention medium 204 extends between the substrates 202 once inserted; heating the retention medium 204 to melt the filler and to allow the liquid filler to wet (and preferably chemically react with) each substrate 202. After a predetermined period of time (e.g., a period of time sufficient for an intermetallic layer to develop between the filler and each substrate 202), heating of the retention medium is stopped/reduced and the filler solidifies to thereby establish the joint 200 between the substrates 202. Such a pre-impregnated retention medium will be referred to as a “foil”.

The retention medium 204 may be pre-impregnated with filler to form the foil by dipping/immersing the retention medium in a pool of liquid filler so that the filler infiltrates the retention medium. As referred to above, the retention medium 204 may comprise a plurality of network layers stacked upon one another. The stack may formed after solidification of the filler in this pre-impregnation process. An advantage of pre-impregnating the retention medium is that the process can be more easily controlled and optimised compared to in-situ impregnation (see below). A high filling fraction (e.g., >95%) of the retention medium with filler is therefore possible and the degree of trapped gas/vacuum in the retention medium can be minimised. Moreover, the “anchoring” intermetallic layer can be formed before the substrates 202 are joined together, meaning fewer surfaces need to be wet with the filler during joining. Ultimately, this reduces the risk of trapping gas or forming voids in the joint.

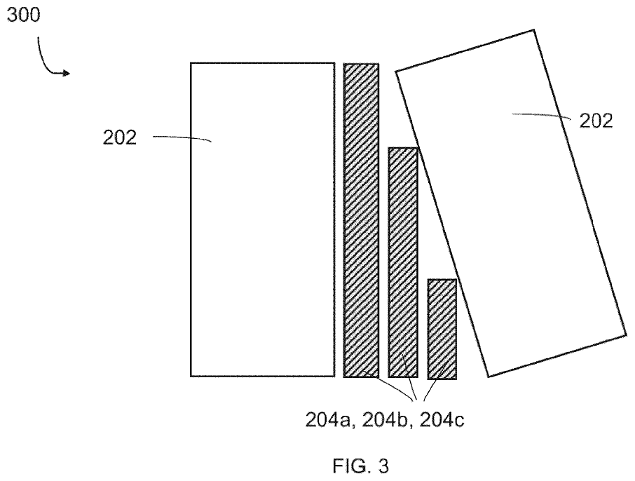

However, pre-impregnating the retention medium 204 with filler reduces the compliance of the retention medium. Planar retention mediums may not be suited for joining together non co-planar substrates, i.e. substrates at an oblique angle to each other. However, with reference to FIG. 3, a joint 300 between non co-planar substrates 202 may be formed using a stack of foils 204a, 204b, 204c of differing length in order to accommodate for the variable-thickness gap, such that the resulting stack substantially extends across the gap between the substrates. Each foil 204a, 204b, 204c can be inserted between the substrates 202 and heated (as described above) sequentially or concurrently with the other retention medium 204a, 204b, 204c. Compressing the stack between the substrates as the stack is heated may improve the compliance of a stack with non-co-planar substrates.

Alternatively, the retention medium may be shaped such that, following impregnation, it can be inserted between two non-coplanar substrates to fill the space to be jointed. The skilled reader will appreciate that the desired shape of the retention medium is set by the shape and relative positioning of the substrates, which varies in practice. Referring back to FIG. 3, the desired shape of the foil is a wedge, having a thickness that varies along its length. However, in another example, the desired shape may be annular and of constant thickness.

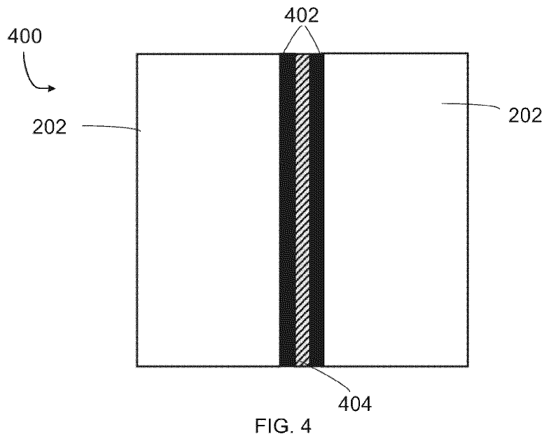

Referring now to FIG. 4, a joint to-be-made 400 is shown, comprising one or more layers of filler material 402 (e.g., a sheet or preform of filler having a thickness less than the threshold described above) and one or more layers of retention medium(s) 404 arranged between two substrates 202. The retention medium layers 404 are not pre-impregnated with filler and hence are compliant. Similarly, the filler layers 402, being in sheet form, are also compliant. Such an arrangement is well-suited to joining non co-planar substrates because the layers 402 and retention medium 404 are sufficiently malleable to fit the variable-thickness gap to be filled between the substrates 202. Nevertheless, pre-impregnated retention mediums may be used as some or all of the retention medium layers 404.

Each of the one or more retention mediums 404 in the joint assembly may be located immediately adjacent to one or more of the filler layers 402, for example, in an alternating arrangement. Alternatively, as in the example illustrated in FIG. 4, filler layers 402 may be provided directly on one or both of the two substrates 202, with a stack of retention mediums 404 (and/or retention medium foils) between them.

The joint 400 may be generated by: forming a stack of the one or more filler layers 402 and one or more retention medium layers 404; inserting the stack between the substrates 202, wherein the stack extends between the substrates 202; heating the one or more filler layers 402 and retention medium layers 404 until the filler layers 402 melt and for a sufficiently long period to allow the liquid filler to: i) infiltrate the retention medium layers 404 through capillary action; and ii) chemically wet the retention medium layers 404 and each substrate 202 to form the anchoring intermetallic layer. Thereafter, any remaining liquid filler is allowed to solidify to establish the joint.

Alternatively, the joint 400 may be generated by: forming a stack of one or more foils, each foil comprising a retention medium layer 404 impregnated with filler material; inserting the stack between the substrates 202; heating the stack of foils such that the filler material melts and wets each substrate. As has already been mentioned, the retention medium may include interstices of a size sufficiently small that melted filler material is, at least partially, retained within the interstices by surface tension. The joint can, therefore, be assembled in any configuration without substantial loss of melted filler material. Thereafter, the filler material is allowed to solidify to establish the joint.

A combination of the above techniques may also be used depending on the size and shape of the gap between the substrates 202. For example, filler layers 402 may be provided on one or both the substrates with a stack of retention mediums 404 between them. Some or all of the retention mediums 404 may be pre-impregnated foils to increase the quantity of filler material within the gap and to help ensure that the filler material bridges the gap to establish the joint.

Preferably, although this is not essential, the joint 400 is formed under vacuum or partial vacuum conditions. The joint of FIG. 2 may also be formed under vacuum or partial vacuum. Under such conditions, gas present within the retention medium 404 or between layers 402, 404 can be removed to avoid or reduce entrapment of gas in the joint after solidification of the filler. A pre-impregnated retention medium is advantageous in that such entrapped gas is usually not initially present before joining.

Referring back to FIG. 2B, the total volume of liquid filler that can be held within the retention medium 204, 404 (its capacity) is determined by the total interstitial volume. This, in turn, is dependent on the structure (e.g., hexagonal, cubic etc.), interstice size 208, etc. As void formation can adversely affect the quality of a joint, the total volume of filler layers 402 preferably matches or is greater than the total capacity of the retention medium 404 to hold filler. This ensures there is sufficient (or excess) filler to fill the retention medium 204, 404.

Moreover, if there are a plurality of retention medium 404, then the total volume of the filler layers 402 immediately adjacent to each retention medium 404 is equal to, or larger than the capacity of the retention medium 404. Preferably, no two filler layers 402 in the stack arrangement are immediately adjacent to other another because the solid-solid interface between the filler layers could lead to entrapment of gas within the joint 400.

As the minimum dimension of the interstices within the retention medium 204, 404 is no higher than the threshold described above, the thickness and/or number of the filler layers 402 can be chosen to ensure there is a sufficient volume of filler for each retention medium 404. That being said, the thickness of the filler layers 402 should remain low enough that the layers 402 remain compliant enough to be shaped.

The retention medium layers 404 may also have differing length such that the stacks described above are able to fill the space between non-coplanar substrates prior to joining, as for example shown in FIG. 3.

In the preceding examples, retention medium 404 layer(s) are shown as planar but this is not essential. For example, the retention medium 404 might be shaped such that its fills the space between two non-coplanar substrates prior to joining. Filler layers 402 of appropriate number and thickness may then be provided adjacent to the shaped retention medium 404 in the stack.

It is noted that melting results in a volume increase, whereas solidification results in a volume decrease. The volume of the filler layers 402 referred to above relate to the volume of the solid filler. For example, if the total volume of the (solid) filler layers 402 substantially matches the total capacity of the retention medium(s) 404, then the volume of liquid produced by melting the filler layers 402 will be larger than the capacity of the retention medium(s) 404. However, during solidification, shrinkage occurs, which induces a pressure drop that ideally leads to uptake of at least part of the remaining liquid filler to effectively fill any remaining voids within the retention medium 404. Any excess liquid filler either wets the substrates 202 and the opposing exterior surfaces of the retention medium 404 and solidifies to fill the space therebetween; or wets opposing exterior surfaces of adjacent retention medium(s) 404 and solidifies to fill the space therebetween.

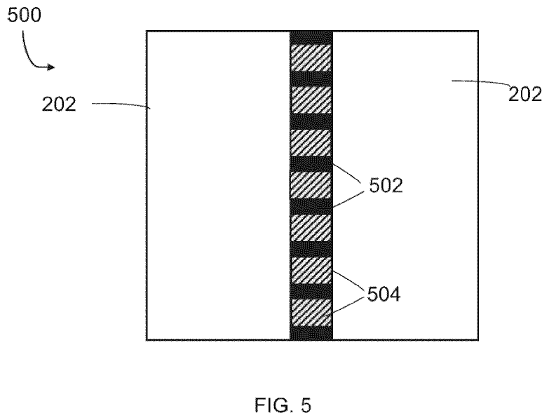

As has already been mentioned, the retention medium 404 may act as a barrier to thermal and/or electrical conduction, adversely affecting the thermal and electrical conductivity of the resulting joint. FIG. 5 shows a joint to be made 500 between two substrates 202, comprising a plurality of retention medium 504 and filler layers 502 (e.g., sheets of filler material as described above), wherein, prior to joining, the layers 504, 502 are arranged orthogonal to (rather than being arranged parallel as in FIG. 4) the substrates 202 to be joined. In this arrangement, the joint 500 comprises high conductivity channels (any excess filler layer 502) with an absence of a thermal/electrical barrier. The thermal and electrical conductivity of the joint 500 is therefore improved compared with the joint 400 shown in FIG. 4. In these examples, the total volume of filler layers 502 is larger than the total capacity of the retention medium 504, such that the “high conductivity” channels can develop. As with joint 400, the joint 500 is formed by: preparing the stack of one or more filler layers 502 and retention medium layers 504; inserting the stack between the substrates 202, wherein the stack extends between the substrates; heating the one or more filler layers 502 and retention medium layers 504 until the filler layers 502 melt and for a sufficiently long period to allow the liquid filler to: i) infiltrate the retention medium layers 504 through capillary action; and ii) chemically wet the retention medium layers 504 and each substrate 202 to form the anchoring intermetallic layer. Thereafter, allowing any remaining liquid filler to solidify to establish the joint 500.

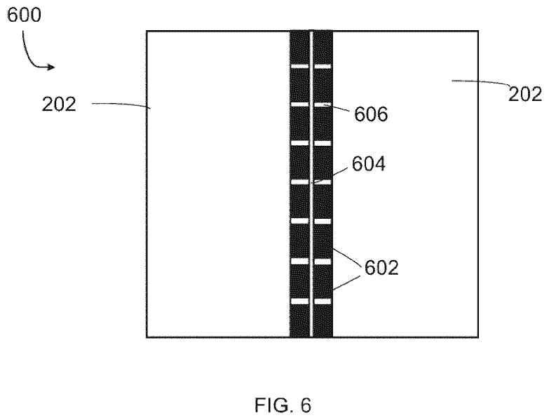

FIG. 6 shows another joint to-be-made 600 between two substrates 202, comprising: a retention medium having an elongate core element 604 from which a plurality of transverse elements 606 extend outwardly to one of the substrates 202; and a plurality of filler layers 602 arranged between the transverse elements 606. The spacing between adjacent transverse elements 606 is no greater than the threshold referred to above. In effect, the spacing between transverse elements 606, the central element 604 and each substrate 202 606 define an interstice having a minimum dimension no greater than the above described threshold. In some examples, a plurality of filler layers 602 is arranged within each defined interstice. As described above, the total volume of filler layers 602 is such that the retention medium 604, 606 may be filled with filler without leaving voids. That is, the volume of filler in the filler layers 602 is equal to, or greater than the capacity of the retention medium. The transverse elements 606 are this example are similar to bristles of a paint brush. Similar to joints 400, 500, joint 600 is formed by: arranging the one or more filler layers 602 between the transverse elements 606 of the retention medium to form a stack; inserting the resulting stack between the substrates 202, wherein said stack extends between the substrates; heating the one or more filler layers 602 and retention medium until the filler layers 602 melt and for a sufficiently long period to allow the liquid filler to: i) infiltrate the retention medium 604, 606 through capillary action; and ii) chemically wet the retention medium layers 604, 606 and each substrate 202 to form the anchoring intermetallic layer. Thereafter, any remaining liquid filler is allowed to solidify to establish the joint 600.

Appropriate fluxes known to the skilled reader may be used to, for example, eliminate or reduce surface oxides present on the surfaces of the substrates to be joined and/or the retention medium before impregnation, where applicable.

The retention medium may be comprised from: copper, brass, stainless steel, nickel, gold, silver, alloys thereof or a surface treated carbon or glass fibres and coated with any of the above.

The filler may be comprised from lead-tin, Sn, In, and other solders known to the skilled reader (e.g., lead-free, high temperature solders, low or ultra-low temperature solders). The filler may instead be silver, copper, copper-zinc (brass), copper-tin (bronze), gold, a gold-silver alloy or other known brazes known to the skilled reader.

The material selection of the retention medium 204 and filler preferably, although not necessarily, ensures that the filler can wet and can form an intermetallic layer with the retention medium, such that, the (solid) filler is anchored effectively in the retention medium once the joint has been formed. The melting point of the retention medium 204 is higher than the melting point of the filler, and the heating of the joint to-be-made melts the filler material but not the retention medium.

The substrate may be comprised from nickel or nickel alloy, copper or copper alloy, brass or brass-containing alloy, or stainless steel or stainless steel containing alloy.

In a specific example, each substrate to be joined is a magnet (e.g., a pancake coil). In another example, at least one of the substrates is a current lead terminal (e.g., in a cryostat).

In yet another specific example, each substrate to be joined is a coil of a superconducting magnet. For example, a limb of a toroidal field coil in plasma confinement vessel. Even more specifically, each substrate to be joined is a terminal comprising superconducting tapes (e.g., HTS ReBCO) or windings encapsulated/laminated contained within copper or other suitable metallic material. The plasma confinement vessel may be a tokamak, preferably a spherical tokamak. Preferably, but not necessarily, the aspect ratio of the spherical tokamak is less than or equal to 2.5. The aspect ratio is the ratio of the major and minor radii of the toroidal plasma-confining regions of the tokamak. The plasma containment vessel may instead be a stellarator or other plasma confinement system. Each limb may be several metres in length.

The invention is summarised in the following numbered clauses:

Clause 1: An apparatus comprising a first substrate, a second substrate and a joint between the first substrate and the second substrate, the joint comprising: at least one retention medium arranged between the first and second substrate and defining at least one interstice having a minimum dimension no higher than a threshold, such that a shortest distance between any point within one of the at least one interstice and the retention medium is no higher than half of said threshold; and a filler material arranged between the first and second substrate and within the at least one interstice, wherein the threshold is less than or equal to 225 μm.

Clause 2: The apparatus of clause 1, wherein the threshold is less than or equal to 200 μm, more preferably less than or equal to 150 μm, even more preferably less than or equal to 125 μm or 100 μm.

Clause 3: The apparatus of any of clauses 1 to 2, wherein the at least one retention medium comprises a plurality of interconnected elements, which define said at least one interstice.

Clause 4: The apparatus of any one of the preceding clauses, wherein the at least retention medium is a single retention medium of size and shape that fills the space between the first and second substrate.

Clause 5: The apparatus of clause 4, wherein the retention medium has variable thickness.

Clause 6: The apparatus of any one of clauses 1 to 3, wherein the joint comprises a plurality of retention mediums.

Clause 7: The apparatus according to clause 6, wherein each of the plurality of retention mediums extends between the first and second substrate.

Clause 8: The apparatus according to clause 6, wherein the plurality of retention mediums are of differing length.

Clause 9: The apparatus according to any one of clauses 1 to 3, wherein the retention medium comprises an elongate core element from which a plurality of transverse elements extend outwardly to the first or second substrate, and the spacing between said transverse elements defines said at least one interstice.

Clause 10: The apparatus according to any preceding clause, wherein each substrate is a limb of a toroidal field coil in a plasma confinement vessel.

Clause 11: The apparatus according to any preceding clause, wherein the retention medium is comprised from: copper or an alloy thereof, brass or an alloy thereof, stainless steel or an alloy thereof, nickel or an alloy thereof, gold or an alloy thereof, or, silver or an alloy thereof.

Clause 12: The apparatus according to any one of clauses 1 to 10, wherein the retention medium is comprised from carbon fibre or glass fibre coated with copper or an alloy thereof, brass or an alloy thereof, stainless steel or an alloy thereof, nickel or an alloy thereof, gold or an alloy thereof, silver or an alloy thereof.

Clause 13: The apparatus according to any preceding clause, wherein the filler material is a solder.

Clause 14: The apparatus according to any preceding clause, wherein the filler material is a braze, comprising silver, copper, brass, bronze, gold or a gold-silver alloy.

Clause 15: A plasma confinement vessel, comprising the apparatus according to any of clauses 1 to 14, wherein each of the first and second substrates are a coil of a superconducting magnet.

Clause 16: The plasma confinement vessel according to clauses 15, wherein the plasma confinement vessel is a tokamak, preferably a spherical tokamak, and more preferably a spherical tokamak having an aspect ratio of less than or equal to 2.5, the aspect ratio being defined as the ratio of the major and minor radii of a toroidal plasma-confining region of the tokamak, and wherein each of the first and second substrates are a toroidal field coil.

Clause 17: The plasma confinement vessel according to clause 15, wherein the plasma confinement vessel is a stellarator.

Clause 18: A method of joining a first substrate and a second substrate to thereby form a joint, the method comprising: inserting a retention medium, pre-impregnated with a filler material, between the first and second substrate, wherein the retention medium extends between said substrates and defines at least one interstice having a minimum dimension no higher than a threshold of less than or equal to 225 μm, such that a shortest distance between any point within one of the at least one interstice and the retention medium is no higher than half of said threshold; heating the filler material until melting, such that said melted filler material chemically wets said substrates; and allowing said filler material to solidify to form the joint, whereby, during said step of melting the filler material, said melted filler material is, at least partially, held within the retention medium.

Clause 19: A method of joining a first substrate and a second substrate to thereby form a joint, the method comprising: arranging one or more filler material layers and one or one retention medium layers to form a stack, wherein each of the one or more retention medium layer defines at least one interstice having a minimum dimension no higher than a threshold of less than or equal to 225 μm, such that a shortest distance between any point within one of the at least one interstice and the retention medium is no higher than half of said threshold; inserting said stack between the first and second substrate, wherein said stack extends between the first and second substrate; heating the one or more filler material layers until melting, such that melted filler material chemically wets the retention medium layers, and the first and second substrate, and the melted filler material infiltrates the retention medium layers through capillary action; and allowing said filler material to solidify to form the joint.

Clause 20: The method according to clause 19, wherein the number and/or thickness of the filler material layers in said stack is such that the volume of filler material is greater than or equal to the total volume of the at least one interstice defined by the one or more retention medium layers.

Clause 21: The method according to any one of clauses 19 to 20, wherein each of the one or more retention medium layers is located immediately adjacent to one or more filler material layers in said stack.

Clause 22: The method according to any of clauses 18 to 21, wherein the joint is formed under vacuum.

Although the invention has been described in terms of preferred embodiments, as set forth above, it should be understood that these embodiments are illustrative only and that the claims are not limited to those embodiments. Features from different examples may be combined as appropriate to form other working examples.

1. A method of joining a first substrate and a second substrate to thereby form a joint, the method comprising:
providing a stack, comprising filler material and a plurality of retention mediums, between the first and second substrate;
heating the stack to melt the filler material and to wet the first and second substrate with melted filler material; and
allowing said melted filler material to solidify to form the joint.

2. The method according to claim 1, wherein each retention medium is an open structure comprising a plurality of interconnected or interlaced elements.

3. The method according to claim 2, wherein the open structure comprises a mesh.

4. The method according to any claim 1, wherein each retention medium defines a plurality of interstices and the size of the interstices is such that melted filler material can infiltrate the retention medium through capillary action and/or the melted filler material is retained within the interstices by surface tension.

5. The method according to claim 4, wherein a minimum dimension of the interstices in each retention medium is no higher than a threshold, such that a shortest distance between any point within one of the interstices and the retention medium is no higher than half of said threshold, and wherein the threshold is less than or equal to 225 μm.

6. The method according to claim 4, wherein the size of the interstices in each retention medium is in the range 10 to 200 μm.

7. The method according to claim 1, further comprising:
providing one or more further stacks, each comprising filler material and a plurality of retention mediums, between the first and second substrate,
wherein, the number of retention mediums arranged in said stacks varies.

8. The method according to claim 1, in which the first and second substrates are at an oblique angle with respect to one another and a number of retention mediums in the stack varies across the first and second substrates such that a height of the stack varies.

9. The method according to claim 1, wherein a length of the retention mediums in the stack varies monotonically between the first and second substrate.

10. The method according to claim 1, wherein the step of providing the stack and/or the one or more further stacks comprises:
arranging a plurality of foils to form a stack, wherein each foil comprises a retention medium impregnated with filler material.

11. The method according to claim 1, wherein the step of providing the stack and/or the one or more further stacks comprises:
arranging at least one filler material layer and a plurality of retention mediums to form a stack.

12. The method according to claim 1, wherein a thickness of each retention medium is in a range of 25 to 200 μm.

13. The method according to claim 1, further comprising:
compressing the or each stack, comprising filler material and the plurality of retention mediums, between the first and second substrate.

14. An apparatus comprising a first substrate, a second substrate and a joint between the first substrate and the second substrate, the joint comprising:
a plurality of retention mediums arranged to form a stack between the first and second substrate; and
filler material extending between the first and second substrate and through the stack.

15. The apparatus according to claim 14, wherein each retention medium is an open structure comprising a plurality of interconnected or interlaced elements.

16. The apparatus according to claim 15, wherein each retention medium comprises a mesh.

17. The apparatus according to claim 14, further comprising:
one or more further stacks comprising a respective plurality of retention mediums between the first and second substrate,
wherein, filler material extends through each of the stacks, and
wherein, the number of retention mediums arranged in the stacks varies.

18. The apparatus according to claim 14, in which the first and second substrates are at an oblique angle with respect to one another and a number of retention mediums in the stack varies across the first and second substrates such that a height of the stack varies.

19. The apparatus according to claim 14, wherein a length of the retention mediums in the stack varies monotonically between the first and second substrate.

20. The apparatus according to claim 14, wherein a minimum dimension of the interstices in each retention medium is no higher than a threshold, such that a shortest distance between any point within one of the interstices and the retention medium is no higher than half of said threshold, and wherein the threshold is less than or equal to 225 μm.

21. The apparatus according to claim 14, wherein a thickness of each retention medium is in a range of 25 to 200 μm.

22. The apparatus according to claim 14, wherein the retention medium is comprised from: copper or an alloy thereof, brass or an alloy thereof, stainless steel or an alloy thereof, nickel or an alloy thereof, gold or an alloy thereof, or, silver or an alloy thereof.

23. The apparatus according to claim 14, wherein each substrate is a limb of a toroidal field coil in a plasma confinement vessel.

24. The apparatus according to claim 14, wherein the filler material comprises silver, copper, brass, bronze, gold or a gold-silver alloy.

25. A plasma confinement vessel, comprising the apparatus according to claim 14, wherein each of the first and second substrates are a coil of a superconducting magnet

26. The plasma confinement vessel according to claim 25 wherein the plasma confinement vessel is a tokamak and wherein each of the first and second substrates are a toroidal field coil.

27. The plasma confinement vessel according to claim 25, wherein the plasma confinement vessel is a stellarator.
